(19) United States
(12) Patent Application Publication
(10) Pub. No.: US 2008/0116257 A1
(43) Pub. Date: May 22, 2008

(54) Method of duplicate check detection in a check image capture application

(75) Inventor: Douglas A. Fickling, Waterloo (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/585,644

(22) Filed: Oct. 24, 2006

(51) Int. Cl. G07F 19/00; G06Q 40/00

(52) U.S. Cl. 235/379; 705/45

(57) ABSTRACT

A method of duplicate check detection in a remote check image capture application comprises receiving check image data which is representative of an image of a check provided by a user at a remote check image capture device, storing the check image data in a check item database, determining a hash result based upon the check image data received from the user, and comparing the hash result with other hash results stored in a hashing database to determine if there is a match and thereby to allow a determination to be made as to whether the check image data received from the user is representative of a duplicate check provided by the user at the remote check image capture device.

### BACKGROUND

The present invention relates to duplicate check detection, and is particularly directed to a method of duplicate check detection in a check image capture application.

In a typical check image capture application, a check image capture device is located remote from a back office facility of a financial institution. The remote check image capture device captures images of checks as the checks are scanned using the device. There are a number of forms that the remote check image capture device may take. The remote check image capture device may be in the form of a table-top check processing terminal. The table-top check processing terminal may be located at a bank branch, for example, where bank personnel use the terminal to perform check processing functions. As another example, the table-top check processing terminal may be located at a merchant's office facility where check image capture processing is performed. Still as another example, the table-top check processing terminal may be located at a point-of-sale (POS) terminal.

The table-top check processing terminal usually comprises a hand-drop check feeder, a check transport mechanism including an alignment mechanism for aligning a check, a magnetic ink recognition character (MICR) head for reading magnetic details on a code line of a check, an imager for capturing front and rear images of a check, a check image data memory for storing images of checks, a printer for endorsing a check, and a number of check storage bins in the form of pockets for storing processed checks. The table-top check processing terminal also includes a controller for controlling operation of the terminal.

Yet as another example, the remote check image capture device may be in the form of an image-based self-service depositing terminal, such as an image-based check depositing automated teller machine (ATM) at which a check can be deposited. A typical image-based check depositing ATM captures check image data which is representative of checks deposited at the ATM. Check image data is initially captured in a “first pass” of checks through the ATM. The remotely-captured check image data is then sent electronically to the back office facility. At a later time (typically weekly), the checks may be picked up at the ATM and physically transported via courier to the back office facility. Then, in a “second pass” of checks through an image-based check processing system located at the back office facility, the checks are matched up with their corresponding check image data which was previously captured at the ATM. The checks are then further processed as required.

Since checks can be scanned at remote locations, such as at ATMs and POS terminals, there is potential for check fraud when a check is intentionally scanned more than once. There is also potential for an operator to make a mistake and scan a check more than once. It would be desirable to provide a method of detecting duplicate checks, especially when checks are scanned at a remote location.

### SUMMARY

In accordance with an embodiment of the present invention, a method of duplicate check detection in a remote check image capture application comprises receiving check image data which is representative of an image of a check provided by a user at a remote check image capture device, storing the check image data in a check item database, determining a hash result based upon the check image data received from the user, and comparing the hash result with other hash results stored in a hashing database to determine if there is a match and thereby to allow a determination to be made as to whether the check image data received from the user is representative of a duplicate check provided by the user at the remote check image capture device.

### BRIEF DESCRIPTION OF THE DRAWINGS

In the accompanying drawings:

FIG. 1 is a block diagram of a remote check image capture device and a back office facility of an institution having a check item database and a hashing database;

FIG. 2 is a block diagram showing one form (a table-top check processing terminal) of the remote check image capture device of FIG. 1;

FIG. 3 is a pictorial diagram of another form (an image-based check depositing ATM) of the remote check image capture device of FIG. 1;

FIG. 4 is a simplified schematic diagram of a part (a check processing module) of the ATM of FIG. 3;

FIG. 5 is an elevational view of the check processing module of FIG. 4, looking approximately in the direction of arrow X in FIG. 3, and showing some parts removed and some parts only schematically;

FIG. 6 is a flowchart illustrating steps involved in a check depositing operation;

FIG. 7 is a representation of fields contained in the check item database of FIG. 1;

FIG. 8 is a representation of fields contained in the hashing database of FIG. 1; and

FIG. 9 is a flowchart illustrating steps involved in a duplicate check detection method in accordance with an embodiment of the present invention.

### DETAILED DESCRIPTION

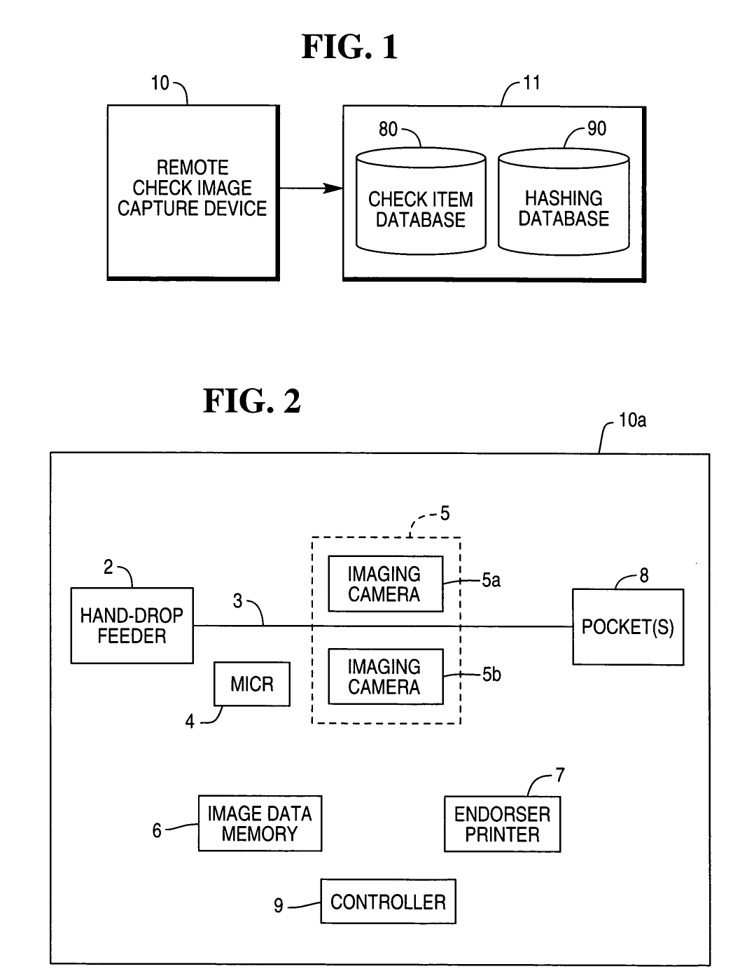

Referring to FIG. 1, a remote check image capture device 10 provides check image data to a back office facility 11 of an institution, such as a financial institution in the form of a bank. A check item database 80 is located at the back office facility 11. A hashing database 90 is located at the back office facility 11. The structure and operation of the check item database 80 and the hashing database 90 will be described later.

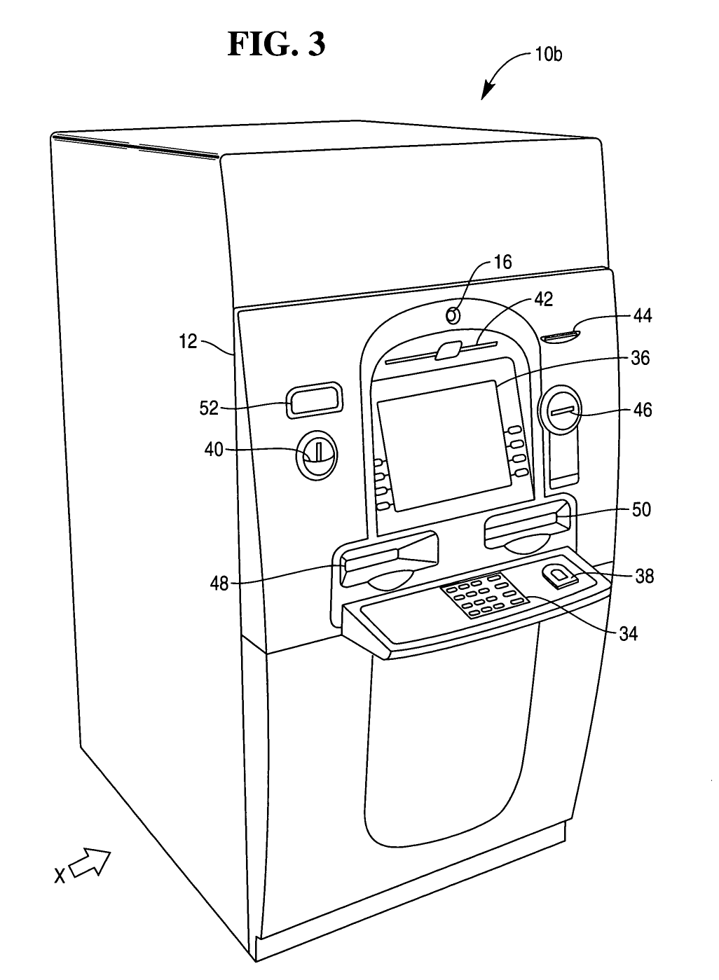

There are many forms that the remote check image capture device 10 may take. One example of the remote check image capture device 10 is in the form of a table-top check processing terminal 10a as shown in FIG. 2. The terminal 10a may be located at a bank branch, for example, where bank personnel use the terminal to perform check processing functions. As another example, the terminal 10a may be located at a merchant's office facility where check image capture processing is performed. Still as another example, the terminal 10a may be located at a point-of-sale (POS) terminal.

The table-top terminal 10a comprises the following elements: a hand-drop check feeder 2, a check transport mechanism 3 including an alignment mechanism for aligning a check; a magnetic ink recognition character (MICR) head 4 for reading magnetic details on a code line of a check; an imager 5 including a first imaging camera 5a and a second imaging camera 5b for capturing an image of each side of a check (front and rear); a check image data memory 6 for storing images of checks; a printer 7 for endorsing a check; and a number of check storage bins 8 in the form of pockets for storing processed checks. An automated check feeder may be used instead of the hand-drop check feeder 2. Also, the use of the MICR head 4 in some applications may be optional. The elements are conventional and will not be described in detail herein. The terminal 10a also includes a controller 9 for controlling the operation of the elements within the terminal.

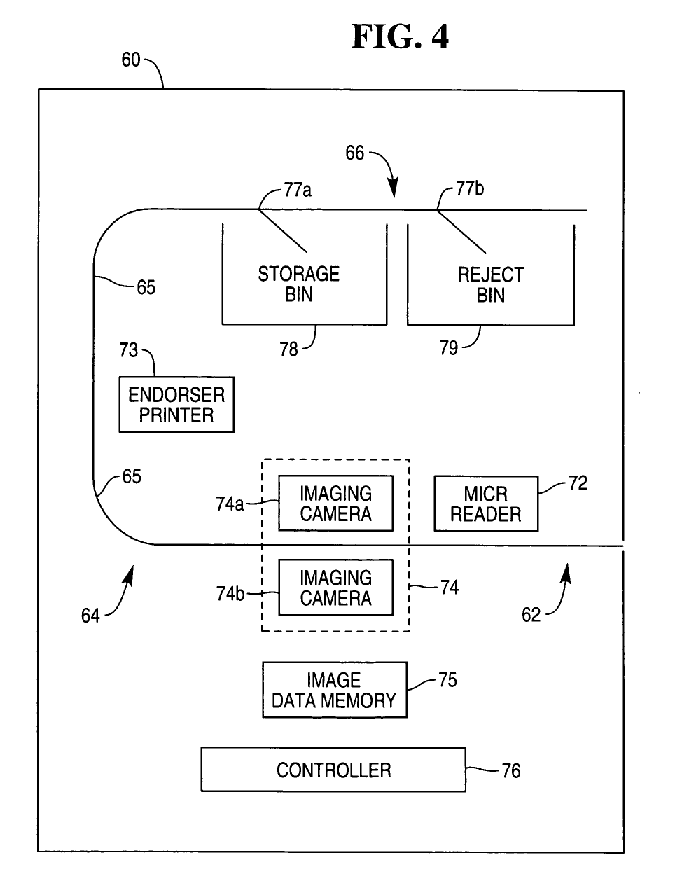

Another example of the remote check image capture device 10 is in the form of an image-based self-service check depositing terminal, such as an image-based check depositing automated teller machine (ATM) 10b as shown in FIG. 3, at which a check can be deposited. The check depositing ATM 10b comprises a fascia 12 coupled to a chassis (not shown). The fascia 12 defines an aperture 16 through which a camera (not shown) images a customer of the ATM 10. The fascia 12 also defines a number of slots for receiving and dispensing media items, and a tray 40 into which coins can be dispensed. The slots include a statement output slot 42, a receipt slot 44, a card reader slot 46, a cash slot 48, another cash slot 50, and a check input/output slot 52. The slots 42 to 52 and tray 40 are arranged such that the slots and tray align with corresponding ATM modules mounted within the chassis of the ATM 10.

The fascia 12 provides a user interface for allowing an ATM customer to execute a transaction. The fascia 12 includes an encrypting keyboard 34 for allowing an ATM customer to enter transaction details. A display 36 is provided for presenting screens to an ATM customer. A fingerprint reader 38 is provided for reading a fingerprint of an ATM customer to identify the ATM customer. The user interface features described above are all provided on an NCR PERSONAS (trademark) 6676 ATM, available from NCR Financial Solutions Group Limited, Discovery Centre, 3 Fulton Road, Dundee, DD2 4SW, Scotland.

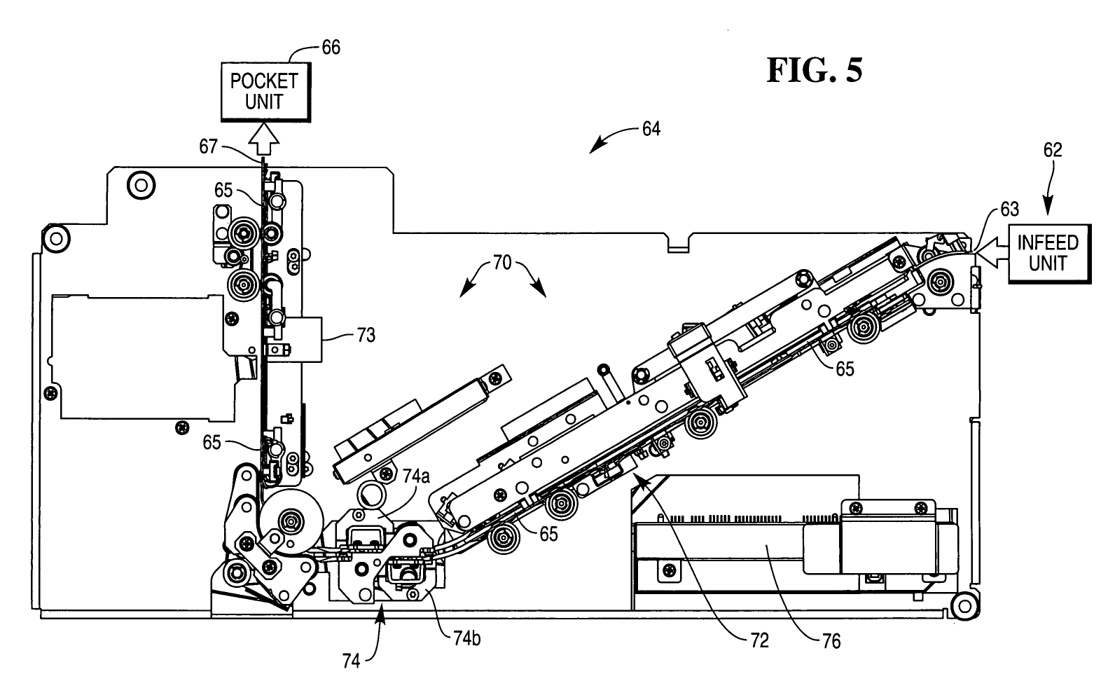

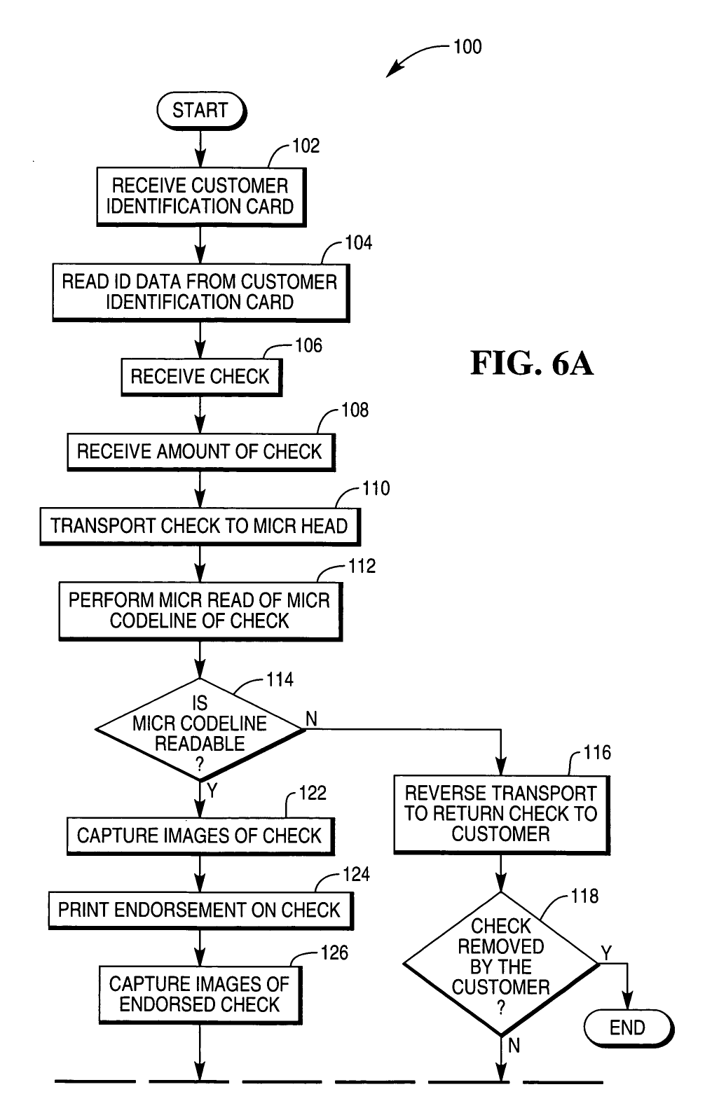

A check processing module (CPM) 60 will now be described with reference to FIG. 4 and FIG. 5. FIG. 4 is a simplified schematic diagram of part of the fascia 12 and main parts of the CPM 60. FIG. 5 is an elevational view of the check processing module of FIG. 2, looking approximately in the direction of arrow X in FIG. 3, and showing some parts removed and some parts only schematically. The CPM 60 is a modified version of a conventional check processing module, such as the check processing module provided with the PERSONAS (trademark) 6676 NCR ATM.

The CPM 60 comprises three main units which includes an infeed unit 62, a transport unit 64, and a pocket unit 66. The infeed unit 62 receives a check which has been deposited into the check input/output slot 42, and transports the check to an inlet 63 of the transport unit 64. The dimensions of the infeed unit 62, such as its run length, may vary depending upon the particular model ATM the CPM 60 is installed. The structure and operation of the infeed unit 62 are conventional and well known and, therefore, will not be described.

The transport unit 64 includes a check input/output transport mechanism 70 which includes an alignment mechanism for aligning a check. The transport mechanism 70 receives a check from the inlet 63, and transports the check along a document track 65 to an outlet 67 of the transport unit 64. The transport unit 64 further includes a magnetic ink character recognition (MICR) head 72 for reading magnetic details on a code line of a check. The transport unit 64 also includes an imager 74 including an upper 74a and lower 74b imaging camera for capturing an image of each side of a check (front and rear). An endorser printer 73 is provided for printing endorsements onto checks. An image data memory 75 is provided for storing images of checks. A controller 76 is provided for controlling the operation of the elements within the CPM 60.

The pocket unit 66 includes a storage bin 78 for storing processed checks. The pocket unit 66 further includes a reject bin 79 for storing rejected checks. Two divert gates 77a, 77b are provided for diverting checks to either the storage bin 78 or the reject bin 79. The structure and operation of the pocket unit 66 are conventional and well known and, therefore, will not be described.

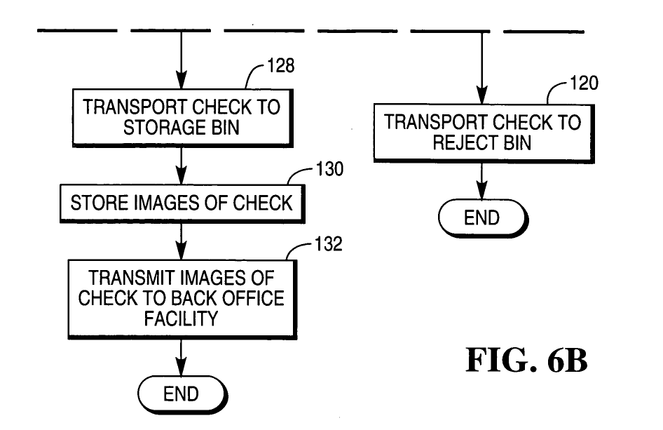

A typical check depositing transaction will now be described with reference to FIG. 6 which is a flowchart 100 illustrating the steps involved in a check depositing transaction, and also with reference to FIGS. 3 to 5. In the check depositing transaction, the ATM customer enters a customer identification card into the card reader slot 46 (steps 102 and 104), selects “check depositing” from a list of transaction options presented on the display 36, enters the amount of the check via the keyboard 34, and inserts the check to be deposited through the check input/output slot 52 (step 106). The controller 76 receives the amount of the check (step 108), and opens a slot entrance shutter located at the infeed unit 62. The transport mechanism 70 receives the check and transports the received check (step 110) to the MICR head 72 where the MICR codeline on the check is read (step 112).

A determination is made (step 114) as to whether the MICR codeline can be read from the check. If the MICR codeline data from the check is unreadable as determined in step 114, then a check return operation is initiated. When this occurs, the transport mechanism 70 reverses the direction of transport (step 116) to convey the check to the check input/output slot 52 to return the check to the ATM customer via the check input/output slot. The controller 76 may monitor the slot 52 to ensure that the check has been removed by the ATM customer (step 118). If the ATM customer has not removed the check within a predetermined time period, the check is retracted and conveyed to the reject bin 79 (step 120).

However, if the MICR codeline data from the check is readable as determined in step 114, then the transport mechanism 70 transports the check to the imager 74, where both sides of the check are imaged (step 122). The printer 73 prints endorsement data onto the check (step 124). The check is then transported to the imager 74 to image the endorsed check (step 126) before it is transported to the storage bin 78 (step 128) for subsequent collection and further processing. Although the above describes both steps 122 and 126 being performed, it is conceivable that only one of these steps be performed. Preferably, step 122 is performed, and step 126 is optionally performed.

The images are stored in the image data memory 75 (step 130). The images may be stored locally to the ATM 10. For example, the images may be stored on an ATM hard drive located within the ATM 10 for a period of time determined by the financial institution. The images are electronically transmitted to the back office facility 11 (step 132) for further processing at the back office facility. This institution may or may not own the particular ATM at which the check has been deposited.

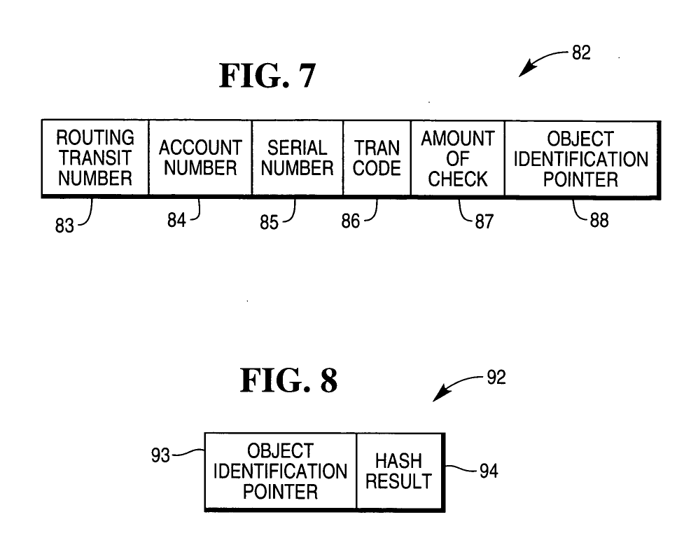

Referring to FIG. 7, a representation of fields 82 of each record contained in the check item database 80 of FIG. 1 is shown. The fields 82 of each record in the check item database 80 include a routing transit number field 83, an account number field 84, a serial number field 85, a tran (transit) code field 86, a check amount field 87, and an object identification pointer field 88.

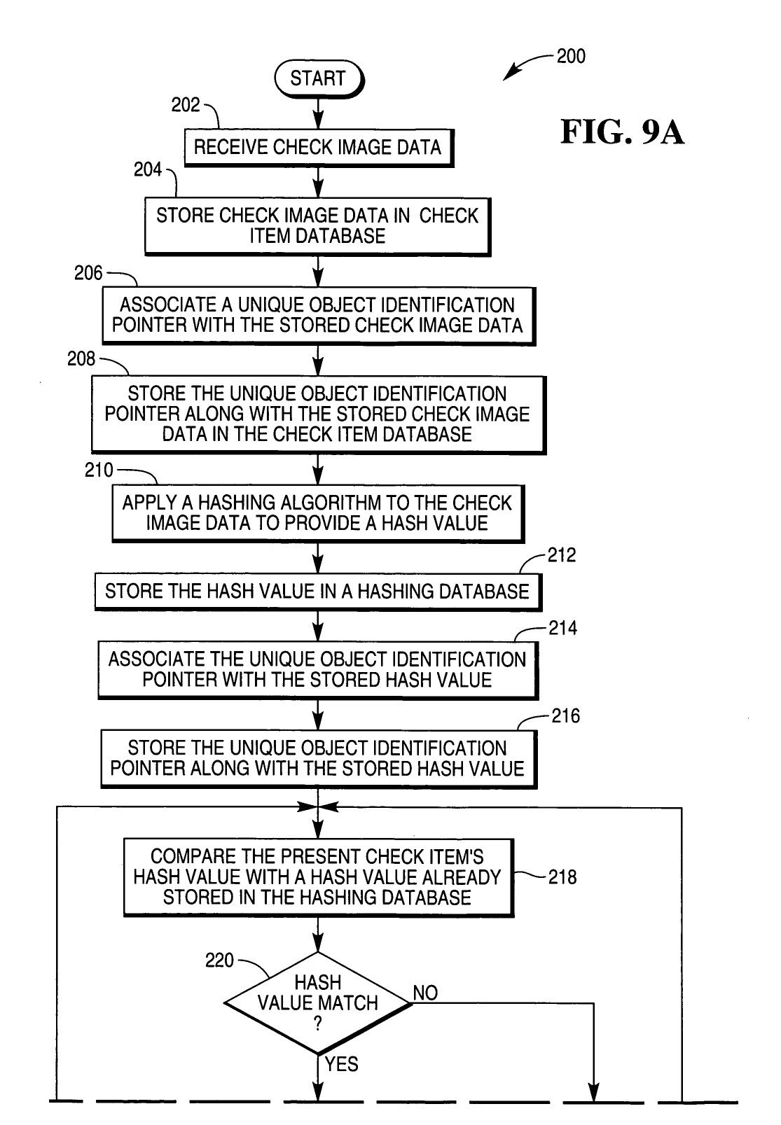

Referring to FIG. 8, a representation of fields contained in the hashing database 90 of FIG. 1 is shown. The fields 92 of each record in the hashing database 90 include an object identification pointer field 93 and a hash result field 94.

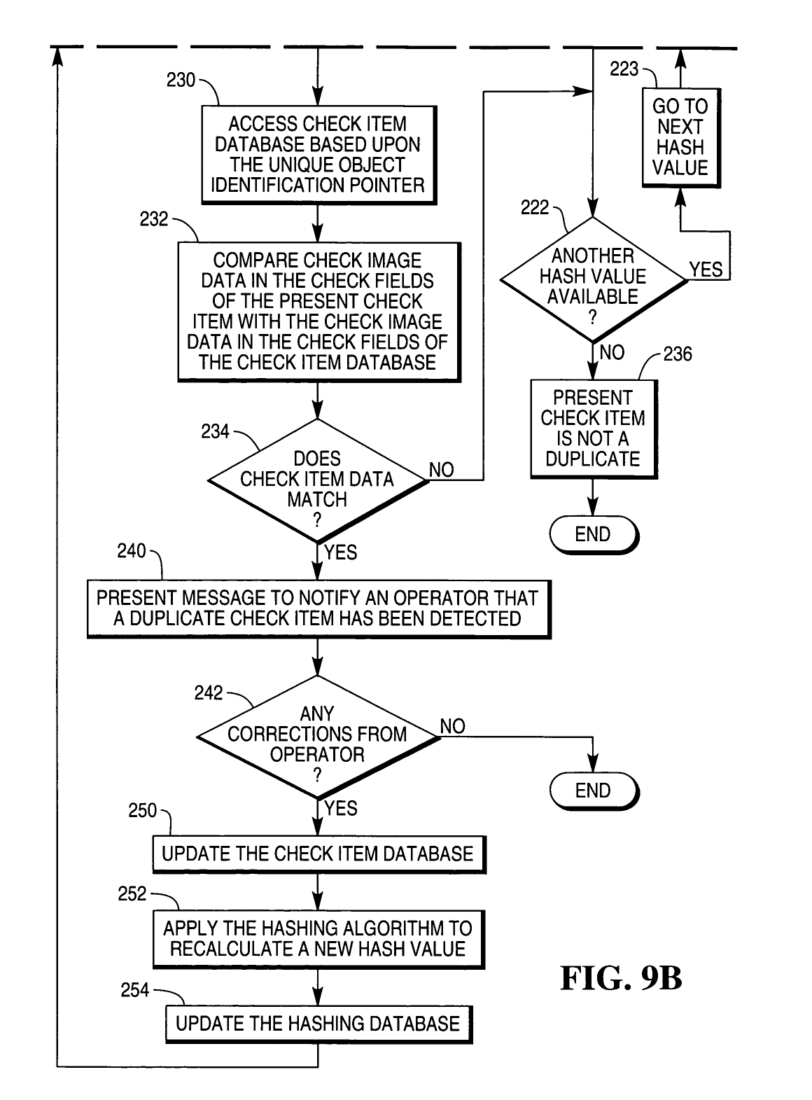

Referring to FIG. 9, a flowchart 200 which illustrates steps involved in a duplicate check detection method in accordance with an embodiment of the present invention. After receiving check image data which is representative of an image of a check provided by a user at a remote check image capture device (step 202), such as the remote check image capture device 10a of FIG. 2 or 10b of FIG. 3, the check image data is stored in a record in the check item database 80 (step 204). More specifically, the check image data is stored in the different fields 83, 84, 85, 86, 87, 88 (FIG. 7). A unique object identification pointer is associated with the check image data being stored (step 206).

A hashing algorithm is then applied to the check image data to provide a hash result which is typically in the form of a hash value (step 210). The order in which the fields of check image data is hashed is preferably check amount, tran code, routing transit number, account number, and serial number. The specific algorithm used to hash the check image data is not important to embodiments of the present invention. The hash value provided in step 210 is stored in the hashing database 90. More specifically, the hash value is stored in the hash result field 94 (FIG. 8). A unique object identification pointer is associated with the hash result being stored in the hashing database 90 (step 214). This unique identification pointer is stored along with the associated hash value (step 216) in the hashing database 90. After the hash value has been stored in the hashing database 90, this hash value is compared with a hash value already stored in the hashing database (step 218).

Then, in step 220, a determination is made as to whether the comparison of step 218 results in a match. If the determination in step 220 is negative (i.e., no match), then a determination is made in step 222 as to whether there is another hash value already in the hashing database 90 for comparing with the present hash value. If the determination in step 222 is negative, then the present check item is determined to be not a duplicate check item (step 236) and the process terminates. However, if the determination in step 222 is affirmative, then the process goes to the next hash value already in the hashing database 90 (step 223) and returns to step 218 to compare the present hash value with the next hash value already in the hashing database. If the process continues to loop through steps 218, 220, and 222 and all hash values already in the hashing database 90 have been compared to the present hash value, then the determination made in step 222 is negative and the present check item is determined to be not a duplicate check item (step 236) and the process terminates.

However, if the determination in step 220 is affirmative (i.e., indicating that that there is a match between the present hash value and a hash value which was already in the hashing database 90), then the process proceeds to step 230. In step 230, based upon the object identification pointer in the field 93 associated with the hash value which was already in the hashing database 90, the corresponding record in the check item database 80 is accessed. The check image data contained in the fields 83, 84, 85, 86, 87, 88 of this corresponding record in the check item database 80 is compared with check image data contained in the fields of the present check item which is being processed.

If the comparison of check image data in step 232 does not match (step 234), then a determination is made in step 222 as to whether there is another hash value already in the hashing database 90 for comparing with the present hash value. If the determination in step 222 is negative, then the present check item is determined to be not a duplicate check item (step 236) and the process terminates. However, if the determination in step 222 is affirmative, then the process goes to the next hash value already in the hashing database 90 (step 223) and returns to step 218 to compare the present hash value with the next hash value already in the hashing database. If the process continues to loop through steps 218, 220, 230, 232, 234, 222, and 223 and all hash values already in the hashing database 90 have been compared to the present hash value, then the determination made in step 222 is negative and the present check item is determined to be not a duplicate check item (step 236) and the process terminates.

However, if the comparison of check image data in step 232 does match (step 234), then the present check item is determined to be a duplicate check item. A message is then presented on a display, for example, to notify an operator that a duplicate check item has been detected (step 240). Then in step 242, a determination is made as to whether the operator has made any corrections to the check image data of the present check item. If the determination in step 242 is negative, then the process terminates (indicating that the operator has reviewed both the check image data of the present check item and the check image data which was already stored in the check item database 80, and has concluded that the present check item is not a duplicate check item).

However, if the operator did make corrections to the present check item (step 242), then the process proceeds to step 250 in which the record of the present check item contained in the check item database 80 is updated with the corrections made by the operator. The hashing algorithm is applied to the check image data of the updated record to recalculate a new hash result for this record (step 252). The corresponding record contained in the hashing database 90 is then updated with this new recalculated hash result (step 254). The process then returns to step 218 to again compare the present check item's new hash value with other hash values already stored in the hashing database 90 to determine if the present check item is a duplicate check item. This process continues until the process terminates at step 222 in which a determination is made that there is not another hash value available for comparison, and that there is not a hash value match as determined in step 220.

It should be apparent that the use of a hashing approach provides a single key index (i.e., the object identification pointer field 93 of the hashing database 90 to the object identification pointer field 88 of the check item database 80) which provides faster access to check item data stored in records of the check item database. The speed of duplicate check detection is thus faster. Since the speed of duplicate check detection is faster, a larger number of check items may be stored, and/or check items may be stored for longer periods of time.

Although the above description describes the check item database 80 and the hashing database 90 as being located at the back office facility 11, it is conceivable that one of both databases may be located remote from the back office facility. It is also conceivable that the databases 80, 90 may be located remote from each other.

Further, although the above description describes the records of the check item database 80 as having the fields 83, 84, 85, 86, 87, it is conceivable that any combination of these particular fields and other fields may be used. It is also conceivable that any combination of these particular fields and other fields may be hashed, and hashed in any order.

Also, although the above-description describes the PERSONAS (trade mark) 6676 NCR ATM embodying the present invention, it is conceivable that other models of ATMs, other types of ATMs, or other types of self-service terminals may embody the present invention. Self-service terminals are generally public-access devices that are designed to allow a user to conduct a transaction or to access information in an unassisted manner and/or in an unattended environment. Self-service terminals typically include some form of tamper resistance so that they are inherently resilient. Self-service terminals allow users to obtain information or to conduct a transaction. Self-service terminals include: ATMs; non-cash kiosks that allow users to access information (e.g., to view reward points on a reward card the user inserts into the self-service terminal); and kiosks that accept payment for services (e.g. Web surfing kiosks, kiosks that allow users to buy goods, etc.). The term self-service terminal has a relatively broad meaning and includes vending machines.

Moreover, although the above-description describes the remote check image capture device 10 (FIG. 1) as being in the form of the image-based check depositing ATM 10b (FIG. 3), the remote check image capture device may be in other forms. As previously mentioned with reference to FIG. 2, the remote check image capture device 10 may comprise a table-top check processing terminal 10a which is located at a bank branch, a merchant's office facility at which check image capture processing is performed, or a POS terminal. The merchant's office facility may be a corporate-type of office facility.

The above locations are only examples of where the table-top check processing terminal 10a can be used. The table-top check processing terminal 10a may be used in other locations at which images of original physical checks are captured. As another example, the table-top check processing terminal 10a may be located at a first bank (which may be a relatively smaller bank), and the back office facility for processing or clearing checks may comprise a second bank (which may be a relatively larger bank). Still as another example, the table-top check processing terminal 10a may be located at any type of bank, and the back office facility may comprise a third party check processing service provider.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of duplicate check detection in a remote check image capture application, the method comprising:
receiving check image data which is representative of an image of a check provided by a user at a remote check image capture device;
storing the check image data in a check item database;
determining a hash result based upon the check image data received from the user; and
comparing the hash result with other hash results stored in a hashing database to determine if there is a match and thereby to allow a determination to be made as to whether the check image data received from the user is representative of a duplicate check provided by the user at the remote check image capture device.

2. A method according to claim 1, further comprising:
storing the hash result in the hashing database to update the hashing database.

3. A method according to claim 2, further comprising:
storing in the hashing database a unique object identification pointer which functions as a single key index to directly access the corresponding check image data stored in the check item database.

4. A method according to claim 3, further comprising:
storing in the check item database a unique object identification pointer which is associated with the object identification pointer stored in the hashing database.

5. A method according to claim 4, wherein the unique object identification pointer stored in the check item database is identical to the object identification pointer stored in the hashing database.

6. A method of operating a back office facility of an institution, the method comprising:
receiving check image data which is representative of an image of a check provided by a user at a remote check image capture device;
storing the check image data in a check item database;
determining a hash value based upon the check image data received from the user;
storing the hash value in a hashing database;
comparing the hash value with other hash values already stored in the hashing database to determine if there is a match;
concluding that the check provided by the user at the remote check image capture device is not a duplicate check when there is no match based upon the comparison of the hash value with the other hash values already stored in the hashing database; and
concluding that the check provided by the user at the remote check image capture device may be a duplicate check when there is a match based upon the comparison of the hash value with the other hash values already stored in the hashing database.

7. A method according to claim 6, further comprising:
comparing check image data associated with the check with other check image data stored in the check item database to determine if there is a match only when there is a match based upon the comparison of the hash value with the other hash values already stored in the hashing database; and
concluding that the check provided by the user at the remote check image capture device is a duplicate check when there is a match based upon the comparison of the check item data associated with the check with other check image data stored in the check item database.

8. A method according to claim 6, wherein (i) the institution comprises a financial institution in the form of a bank, and (ii) the remote check image capture device comprises a table-top check processing terminal located at a merchant's check image capture facility which is located remote from the back office facility of the bank.

9. A method according to claim 6, wherein (i) the institution comprises a financial institution in the form of a bank, and (ii) the remote check image capture device comprises a table-top check processing terminal located at a bank branch which is located remote from the back office facility of the bank.

10. A method according to claim 6, wherein (i) the institution comprises a third party check processing service provider, and (ii) the remote check image capture device comprises a terminal located at a bank which uses the third party check processing service provider to process checks.

11. A method according to claim 6, wherein (i) the institution comprises a first bank at which checks can be processed, and (ii) the remote check image capture device comprises a terminal located at a second bank which is different from the first bank and which uses the first bank to process checks.

12. A method according to claim 6, wherein the remote check image capture device comprises an image-based self-service check depositing terminal.

13. A method according to claim 12, wherein the image-based self-service check depositing terminal comprises an image-based check depositing automated teller machine (ATM).

14. A program storage medium readable by a computer having a memory, the medium tangibly embodying one or more programs of instructions executable by the computer to perform method steps for detecting a duplicate check in a remote check image capture application, the method comprising the steps of:
(a) receiving check image data which is representative of an image of a check provided by a user at a remote check image capture device;
(b) storing the check image data in a check item database;
(c) determining a hash result based upon the check image data received from the user; and
(d) comparing the hash result with other hash results stored in a hashing database to determine if there is a match and thereby to allow a determination to be made as to whether the check image data received from the user is representative of a duplicate check provided by the user at the remote check image capture device.

15. A program storage medium according to claim 14, further comprising:
(e) storing the hash result in the hashing database to update the hashing database.

16. A program storage medium according to claim 15, further comprising:
(f) storing in the hashing database a unique object identification pointer which functions as a single key index to directly access the corresponding check image data stored in the check item database.

17. A program storage medium according to claim 16, further comprising:
(g) storing in the check item database a unique object identification pointer which is associated with the object identification pointer stored in the hashing database.
